(19) United States
(12) Patent Application Publication
(10) Pub. No.: US 2010/0203354 A1
(43) Pub. Date: Aug. 12, 2010

(54) FLATTED MATERIAL

(76) Inventors: Kuniteru Mihara, Tokyo (JP); Tatsuhiko Eguchi, Tokyo (JP)

Correspondence Address: Kubotera & Associates, LLC, 200 Daingerfield Rd, Suite 202, Alexandria, VA, 22314, US

(21) Appl. No.: 12/524,203

(22) PCT Filed: Jan. 25, 2008
(86) PCT No.: PCT/JP2008/051052

§ 371 Date: Apr. 20, 2010

(30) Foreign Application Priority Data
Jan. 26, 2007 (JP) 2007-016064
Jan. 24, 2008 (JP) 2008-014277

(51) Int. Cl. B32B 15/01; C22C 9/04; C22C 9/02

(52) U.S. Cl. 428/647; 420/476

(57) ABSTRACT

Disclosed is a flatted material produced by conducting cold flatting of copper alloy including 0.1-1.0 mass % of Cu, 0.05-1.5 mass % of Sn, and 0.05-1.5 mass % of Zn, and comprising residue Cu and unavoidable impurities. In the flatted material, both of the stress relaxation rates in a direction parallel to the flatting direction and a direction perpendicular to the flatting direction are 50% or less as measured by an insertion type stress relaxation test at 150° C. after 1,000 hours.

### TECHNICAL FIELD

The present invention relates to a flatted material.

### BACKGROUND ART

Conventionally, other than iron based materials, copper based materials, such as phosphor bronze, red brass, brass, and chromium copper alloy, which are excellent in electrical conductivity and heat conductivity, are widely used as a material for lead frames, connectors, terminals, relays, switches, etc., of electric and electronic devices. In recent years, because of a demand for a small size, a light weight, high density implementation, etc., of electric and electronic devices, it is necessary to improve a property of the copper based material such as strength, electrical conductivity, stress relaxation characteristic, plating characteristic, solder weatherability, bending processability, press characteristic, heat resistivity, etc.

In particular, terminals used in electric connection parts, junction boxes (electric connection boxes), control units, etc., for mobile applications such as automobiles and trains are generally referred to as “tuning fork terminals”. The tuning fork terminal is a female terminal formed by elongating or tearing apart a material in a direction parallel to a flatting direction of the material (hereinafter referred to as “parallel direction to the flatting”) and to a direction perpendicular to the flatting direction of the material (hereinafter referred to as the “perpendicular direction to the flatting”). A male tab (generally, a terminal (leg), such as a fuse and a relay) is connected into a space formed in the female terminal (refer to Patent references 1 to 6).

In the application, a chromium copper alloy is a Cu—Cr based alloy having high heat resistivity with Cr particles deposited, and is commercially available as CDA18040 alloy registered in CDA (Copper Development Association). Moreover, an alloy which has improved characteristic of the alloy is also proposed (refer to Patent references 7 and 8).

As a test method of the stress relaxation characteristic of copper and a copper alloy, a method specified in the Electronics Materials Manufacturers Association of Japan (EMAJ) standard (EMAS-3003), or a similar test method (refer to Patent reference 9) is used.

Patent reference 1: Japanese patent publication No. 2005-278285 (refer to FIG. 4-b)
Patent reference 2: Japanese patent publication No. 2005-19259 (refer to FIG. 2)
Patent reference 3: Japanese patent publication No. 2005-312130 (refer to FIG. 2)
Patent reference 4: Japanese patent publication No. 2005-85527 (refer to FIG. 2)
Patent reference 5: Japanese patent publication No. 11-16624 (refer to FIG. 4)
Patent reference 6: Japanese patent publication No. 2005-80460 (refer to FIG. 5)
Patent reference 7: Japanese patent publication No. 64-457
Patent reference 8: Japanese patent publication No. 3-25495
Patent reference 9: Japanese patent publication No. 2006-291356 (refer to paragraph 0055)

### DISCLOSURE OF THE INVENTION

The above-mentioned terminal needs to be connected reliably permanently, and usually, it is desired to have a stress relaxation characteristic which meets a required characteristic value.

However, as to the materials for electrical and electronic devices using the CDA18040 alloy and chromium copper alloy described in Patent references 7 and 8, the stress relaxation characteristic thereof is not in a level having a satisfied characteristic.

Furthermore, the test method of the stress relaxation characteristic disclosed in Patent reference 9 is not suitable for evaluating reliability of the terminal used for the electric and electronic devices of the mobile unit which should consider an influence of vibrations at a tuning fork terminal, especially at a connection portion thereof.

Therefore, a test method of the stress relaxation characteristic representing reliability of a terminal for electric and electronic devices of a mobile unit such as an automobile and a train have been desired. Further, a material satisfying a stress relaxation characteristic evaluated with the test method has been required.

In view of the situation described above, the inventors of the present invention have examined and completed the present invention based on the following knowledge.

(A) A test method of the stress relaxation characteristic desirable for a metal material for electric and electronic devices of a mobile unit which should consider an influence of vibrations at a connection portion is proposed. A copper alloy containing Cr, Sn, and Zn which satisfies the stress relaxation characteristic required for the usage and evaluated with the test method is provided.
(B) By examining a relationship between a particle diameter (a diameter of a compound particle) and a distributing density of a Cr compound dispersed in the copper alloy containing Cr, Sn, and Zn, and further a final cold flatting rate, and a tension strength, an electrical conductivity, and a stress relaxation rate, etc., the characteristics are improved through appropriately adjusting the particle diameter and the dispersion density.

It is an objective of the invention to provide a flatted material formed of a copper alloy for electric and electronic devices, in which tension strengths, electrical conductivity, and stress relaxation characteristic in the parallel direction and the perpendicular direction to the flatting direction are improved.

According to the present invention, the following aspects are provided:

(1) A flatted material formed through cold flatting a copper alloy containing 0.1-1.0 mass % of Cu, 0.05-1.5 mass % of Sn, 0.05-1.5 mass % of Zn, a residual amount of Cu, and unavoidable impurities. The flatted material has stress relaxation rates of 50% or less in a direction parallel to a flatting direction thereof and in a direction perpendicular to the flatting direction after 1,000 hours of an insertion type stress relaxation test at 150° C.
(2) In the flatted material according to (1), the flatted material further has tension strengths of 400 MPa or greater in the direction parallel to the flatting direction and the direction perpendicular to the flatting direction.

The flatted material has electric conductivities of 40% IACS or greater in the direction parallel to the flatting and the direction perpendicular to the flatting direction. The flatted material contains Cr particles having a size of 5-50 nm and a dispersion density of 10²-10³ pieces/μm².

(3) In the flatted material according to (2), the flatted material further has a surface coated with an Sn layer or an Sn alloy layer having a thickness of 0.5-5 μm.
(4) In the flatted material according to one of (1) to (3), wherein the copper alloy constituting the flatted material includes a total amount of 0.005-0.5 mass % of at least one selected from the group consisting of Al, Zr, Ti, Fe, P, Si, and Mg.
(5) In the flatted material according to one of (1) to (4), the flatted material is processed at a final flatting processing rate of 10% to 50%.
(6) The flatted material according to one of (1) to (5) is used for a terminal of a control unit or a bus bar.

The features and advantages described above, and other features and advantages of the present invention will become clear from the following publication with reference to the accompanying drawings.

### BRIEF DESCRIPTION OF THE DRAWINGS

FIG. 1 is a diagram illustrating a test method of an insertion type stress relaxation characteristic.

FIG. 2 is a plan view of a stress relaxation test piece (in a perpendicular direction to the flatting).

### DESCRIPTION OF THE SYMBOLS

1a and 1b stress relaxation test piece
2 transmission slot (slit)
3 insertion member

### BEST MODE FOR IMPLEMENTING THE INVENTION

(Cr)

In the present invention, Cr is limited to 0.1-1.0 mass %. Accordingly, Cr is deposited together with Cr free particles or added elements in a copper alloy sheet/strip material through an optimum heat treatment as described above. As a result, it is possible to improve an electrical conductivity, a stress relaxation characteristic, and heat resistivity. In this case, less than 0.1 mass % is not enough, and exceeding 1.0 mass % is not desirable industrially since the effect thereof is saturated.

(Sn)

Sn is limited to 0.05-1.5 mass %. Accordingly, Sn is dissolved in the copper base material in a solid phase to strengthen, thereby improving the stress relaxation characteristic and heat resistivity. In this case, less than 0.05 mass % is not enough for obtaining the effect, and containing more than 1.5 mass % causes a reduction in the electrical conductivity and inhibits hot processability (causes cracks during a hot flatting processing).

(Zn)

Zn is limited to 0.05-1.5 mass %. Accordingly, Zn is dissolved in the copper base material in a solid phase to strengthen, thereby improving the heat resistivity and solder resistant weatherability. Generally, solder tends to exfoliate at an interfacial surface between the copper base material and a Sn plating, thereby reducing connection reliability. Zn is known to have an effect of suppressing void formation (vacant holes) at the interfacial surface before the exfoliation. It is not effective when the amount is less than 0.05 mass %, and containing more than 1.5 mass % reduces the electrical conductivity and saturates the effect.

(Other Elements)

Furthermore, other than Cr, Sn, and Zn, at least one of a group selected from Al, Zr, Ti, Fe, P, Si, and Mg is properly contained in the copper base material as an element to improve the strength. The effect is not enough if an amount of the element is less than 0.005 mass %, and the electrical conductivity decreases if it exceeds 0.5 mass %. Therefore, a total amount is 0.005-0.5 mass %.

(Flatting Rate)

The tension strength is improved with the final cold flatting rate. When the processing rate is too low, the tension strength is not sufficient. When the processing rate is too high, the stress relaxation characteristic is reduced. Furthermore, the processability worsens when the processing rate is too high. In the present invention, it is desirable that the flatting rate in a cold flatting process applied as a last step in the cold flatting performed in multiple stages, i.e., a plurality of processes, is greater than or equal to 10% and less than or equal to 50%.

It is easily presumed that the flatted material used for a junction box of an automobile application, etc., in which electric connection parts, terminals, bus bars, etc., are disposed, needs to have small anisotropy in the flatting parallel direction and the flatting perpendicular direction.

Usually, an electric device material is bent in a direction limited to either of the flatting parallel direction or the perpendicular direction to the flatting, and required characteristic and a characteristic evaluation method take this into consideration. However, for a bus bar use, as disclosed in Patent references, etc., it is common to perform the bending processing in both of the directions, the parallel direction to the flatting and the perpendicular direction to the flatting. Therefore, when the material has anisotropy in the tension strength and the electrical conductivity, various problems may occur. Moreover, the same is for the stress relaxation characteristic. That is, when the flatted material is used for a bus bar of the control unit of a mobile unit such as an automobile and a train, the characteristic evaluation method needs to suit for the usage. However, Patent references do not disclose the characteristic evaluation method (especially the stress relaxation characteristic of a structure of a tuning fork terminal, etc. as a connected terminal) suitable for the bus bar. Therefore, the characteristic which should be required for the flatted material is not evaluated.

Furthermore, the control units are generally installed in a machinery room of trains and locomotives or an engine room of an automobile. Accordingly, the control units are used in severe environments compared with general electronic devices because of an installation environment (involving vibrations), a temperature environment, a high-concentration corrosion gas atmosphere caused by fuel combustion, and particulate environment, etc. Therefore, in addition to the stress relaxation characteristic, it is preferred that the material used for such use has good heat dissipation and excellent stress corrosion resistance.

In view of the environment, the present invention provides the optimal evaluation method and a relation with the material characteristic.

(Tension Strength, Electrical Conductivity)

First, the tension strengths in the parallel direction to the flatting and the perpendicular direction to the flatting are preferably 400 MPa or more. If it is 400 MPa or less, the material strength is insufficient for a terminal and a bus bar, and it is possible that a deformation may arise when inserting and pulling male terminals such as a fuse and a relay.

Moreover, since junction boxes are installed in the engine room of automobiles in many cases, and a large electric current of tens of amperes (A) flows at the junction box, the higher the electrical conductivity, the generation of Joule heat can be reduced more. Furthermore, since having good electrical conductivity is required in view of dissipation of heat, the electrical conductivity is preferably 40% IACS or more.

(Cr Deposition)

Manufacturing of the flatted material made of copper alloy which has the above-described tension strength and electrical conductivity is achieved by dispersing added Cr into the flatted material. That is, it is accomplished by controlling the dispersion. Here, that is the dimension of the deposited particles of the deposited Cr and its dispersion density (distribution density: meaning surface density of the deposited substance).

Although both the tension strength and the electrical conductivity can be improved by depositing Cr particles, that is obtained only if the dimension and dispersion density are controlled appropriately. As for the dimension, preferably it is 5-50 nm in particle diameter conversion, and more preferably, it is controlled to 5-30 nm.

On the other hand, dispersion density is preferably in a range of 10²-10³ pieces/μm², and more preferably, it is in a range of 10²-5×10² pieces/μm².

The deposited Cr and Cr compounds are accurately analyzed by EDS (energy distributed analysis machine) attached to a transmission electron microscope (TEM).

For example, the dispersion density is obtained as follows:

Thin film test pieces for transmission electron microscopes are produced from the flatted material, and penetrated type electron-microscope observation is carried out with the accelerating voltage 300 kV. As for the observation, a magnification ratio of 5,000 to 250,000 times to observe in directions which can clearly and sharply observe the Cr particles is used. In this case, when measuring the size of an individual Cr particle, photographs are taken from three views with a high magnification ratio (≧×100,000) so that arbitrary 20-50 particles are included in the photograph, and an average particle size is obtained from the photograph. If a Cr particle is flat, ellipse approximation is carried out and the average value of its minor axis and major axis is assumed to be a particle size.

Furthermore, photographs are taken from three views with a low magnification ratio (≦×80,000) so that arbitrary 50-200 Cr particles are included in the photograph, and the average particle density is obtained from the photograph.

As for the control of the deposited substance, it is controlled by the conditions of the aging treatment, which is a heat treatment performed after cold flatting. Small deposited substances are obtained by lowering the aging temperature and shortening the time period. In this case, although tension strength can attain the target characteristic, the target characteristic of electrical conductivity cannot be obtained. On the other hand, large deposited substances are obtained by raising the aging temperature and making the time period longer. In this case, although it is easier to obtain target electrical conductivity, it is more difficult to obtain target tension strength.

Furthermore, the size of the deposited substance also relates to the dispersion density. In a case where the same amount of Cr is added, dispersion density increases if the deposited substance is smaller, and the dispersion density decreases if the size is larger.

Therefore, in order to acquire various characteristics of the present invention, it is desirable to perform aging treatment of 400-650° C.×0.5-4 hours, and in a case where the cold flatting rate before the aging treatment is 80% or more, various characteristics can be obtained by performing the first aging treatment in a condition of 400-500° C.×1-2 hours, and subsequently performing the second aging treatment by 550-650° C.×0.5-1 hour.

In a case where the cold flatting rate before the aging treatment is 50-80%, various characteristics can be obtained by performing the first aging treatment in a condition of 450-550° C.×1-2 hour, and subsequently performing the second aging treatment in a condition of 550-650° C.×0.5-1 hour.

When the cold flatting rate before the aging treatment is less than 50%, various characteristics can be obtained by performing the first aging treatment in a condition of 500-600° C.×1-2 hours and the second aging treatment under in a condition of 600-650° C.×0.5-1 hour.

The cold flatting rate before the aging treatment indicates the flatting rate from a high temperature recrystallization treatment (for example, a high temperature solution treatment and a hot flatting).

(Stress Relaxation Characteristic)

A tuning fork terminal used in control units and electric connection boxes, etc., which are incorporated electric and electronic devices, in particular, mobile units, such as automobiles and vehicles, has a female terminal structure which is formed by elongating or tearing apart the flatted material in the parallel direction to the flatting and the perpendicular direction to the flatting to the flatted material, and by connecting a male tab (generally, a terminal or a leg of a fuse, relay, etc.) in a space formed in the tuning fork terminal.

When the male tab is fit in the female tab in use, a phenomenon (so-called stress relaxation) arises where the space in the female terminal widens and a contact pressure with the male tab becomes smaller. Practical problems do not occur when the stress relaxation characteristic is 50% or less after elapsing 150° C.×1,000 hours. When the stress relaxation characteristic exceeds 50%, reliability decreases, thereby setting a threshold.

In a conventional method for testing the stress relaxation characteristic specified in the EMAJ standard (EMAS-3003) or similar test methods (refer to Patent reference 9), the stress relaxation characteristic is evaluated through applying a bending stress to a sample surface. However, the conventional method is not suitable for accurately evaluating the stress relaxation characteristic of the terminals having the above-described shape. Therefore, the present invention found out the following insertion type stress relaxation characteristic test method for evaluating the stress relaxation characteristic of the terminal having the above-mentioned shape, and the stress relaxation characteristic is evaluated based on the test method.

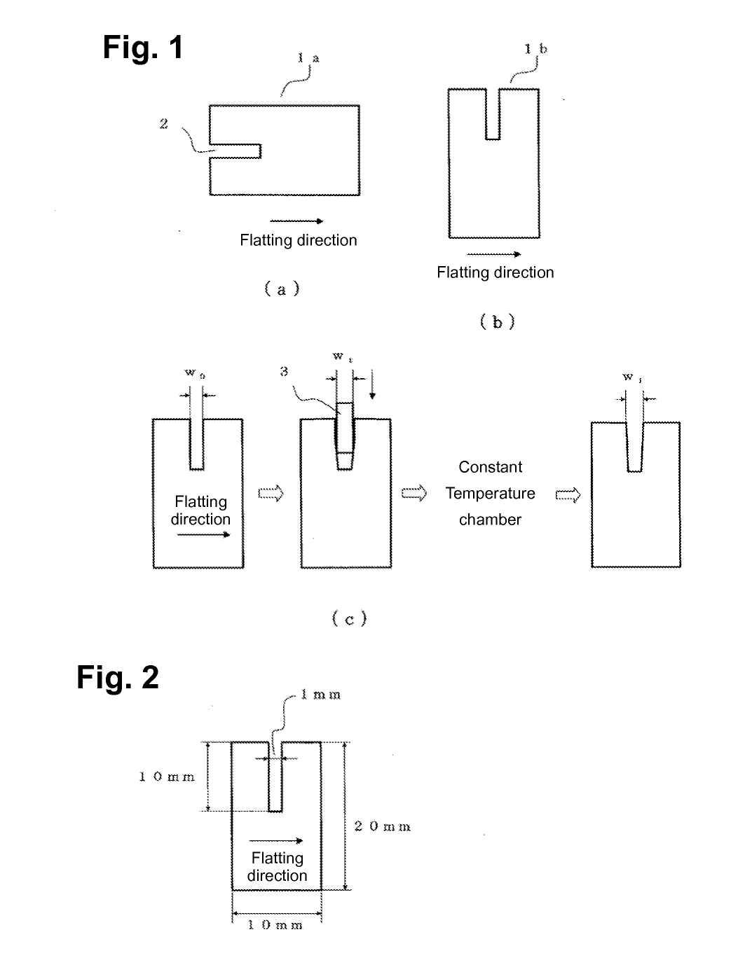

FIG. 1 is a diagram illustrating the test method of the insertion type stress relaxation characteristic according to the present invention. FIG. 1(a) shows a test piece in a direction in parallel to the flatting direction. FIG. 1(b) shows a test piece in a direction perpendicular to the flatting direction. Reference numerals 1a and 1b represent test pieces, and 2 represents a penetrated slot (slit).

FIG. 1(c) illustrates the test method. An insertion type member 3 having a width wt (mm) greater than w0 (mm) is inserted into a penetrated slot 2 having a width w0 (mm). After maintaining at a predetermined test temperature for a predetermined period, the insertion type member 3 is extracted from the penetrated slot 2, and the width w1 (mm) of the penetrated slot 2 is measured.

From the measured w0 and w1, the stress relaxation rate SR (%) is computed using the following Expression 1 to evaluate the stress relaxation characteristic.

Here, the relation between w0 and wt is set under the condition, w0<wt≦1.3×w0. It is possible to obtain a result based on an actual condition through specifying the displacement caused by the insertion, not the stress (bending stress) as an independent variable in the EMAS-3003. In a case where the stress should be evaluated as an independent variable, numerical analyses, such as finite element method analysis, is performed to calculate the stress generated upon insertion.

$$SR = \frac{{w}_{1} - {w}_{0}}{{w}_{0}} \times 100 \qquad [ Expression 1 ]$$

Generally, in an engine room of a car, the temperature may reach 70° C.-100° C. Therefore, the material to be used is required to satisfy the characteristic in the conditions corresponding to such usage.

Accordingly, as for the evaluation condition for the stress relaxation characteristic in the present invention, the test is performed as shown in FIG. 1, and the test condition, especially temperature and time period exposed at the temperature, is 150° C. and 1,000 hours, respectively.

Here, one of the reasons for setting the temperature to 150° C. is to obtain an equivalent result or to presume the result even with a shorter time period than the actual time period, and to improve the efficiency of development and speed by performing the evaluation of the stress relaxation characteristic by an acceleration test, that is, performing the test at a higher temperature than the actual usage environment. In addition, the temperature is set to 150° C. in consideration of the temperature in an engine room which reaches to about 70° C. to 100° C. As for other reasons, the test piece itself tends to be soft at a temperature exceeding 200° C. due to the softening characteristic of the copper alloy used for terminals and bus bars, and therefore, it does not function as a member for terminals and bus bars.

The time period to expose at 150° C. is specified as 1,000 hours of maintaining period, in consideration of, for example, automobile inspections done every two years and periodic inspections prescribed for every half year in automobiles, and alternating inspections having an inspection cycle of 30 days or less and monthly inspections performed within three months in vehicles such as trains.

The reason for setting the stress relaxation rate after 1,000 hour progress at 150° C. in both the parallel and perpendicular direction to the flatting to 50% or less is that the insertion fit of the terminal tends to be loose if the rate exceeds 50%, and therefore, the electric connection becomes unstable due to factors, such as vibrations, and it is likely to cause fault. The stress relaxation rate is preferably, 40% or less.

As to methods to avoid deterioration of the stress relaxation characteristic, it is desirable to reduce the final flatting rate. However, if the final flatting rate is too low, the initial contact pressure cannot be raised high, and therefore, the material does not function as the terminal material. On the other hand, if the final flatting rate is too high, the stress relaxation characteristic will tend to deteriorate, and the bending processability worsens.

(Coating Layer of Sn Layer or Sn Alloy Layer)

It is desirable that an Sn layer or an Sn alloy layer is applied to a surface of the flatted material in the present invention. The Sn layer or Sn alloy layer greatly improve the connection reliability when used as an electric contact while preventing oxidization of the surface of the flatted material. A thin Sn oxide layer is formed on a surface of the coated Sn layer. The thin Sn oxide layer is weak, and is removed during the insertion and the extraction of the terminal to form a new interfacial surface. The interfacial surface serves as an electrical contact, thereby maintaining good electrical contact.

When the Sn layer has a thickness less than 0.5 μm, it is not enough, and if it exceeds 5 μm, it requires large insertion and extraction force, and not suitable for use. Thus, the thickness is preferably, 0.5-5 μm, and 1-2 μm is an appropriate coating thickness for industrial use.

There are various methods to form the Sn layer, and the Sn layer or Sn alloy layer include a reflow Sn plating layer, a non-gloss Sn plating layer, an alloy Sn plating layer, etc. The present invention is not limited to those. Moreover, there are many types of intermediate layers (reaction layers) which are formed in the interfacial surface between the coated Sn layer and the flatted material. The present invention is not limited to those.

The flatted material of the present invention is easily manufactured by specifying reheat condition, hot flatting condition, aging treatment, and final cold flatting condition, before the hot flatting.

The flatted material according to the present invention is formed with a copper alloy containing Cr, Sn, and Zn, which satisfy the stress relaxation characteristic required at the connection region. Therefore, it is useful for electrical and electronic devices, in particular, connectors, terminals, and bus bars of control units which are used in electric and electronic devices equipped in mobile units, such as automobiles, trains, etc. Moreover, various characteristics, especially the tension strength of the parallel direction to the flatting and the perpendicular direction to the flatting, electrical conductivity, stress relaxation characteristic, etc., can be improved by appropriately specifying the final cold flatting rate in the manufacturing process and the particle diameter of Cr dispersed into the flatted material. Furthermore, by specifying the above-mentioned final cold flatting rate and the degree of dispersion of the Cr compound, the above characteristics improve further. Moreover, the strength and press workability of a copper alloy are improved by containing at least one chosen from a group consisting of Al, Zr, Ti, Fe, P, Si, and Mg into the above-mentioned copper alloy.

### EXAMPLES

Hereinafter, the present invention will be described in detail by Examples. However, it is noted that the present invention is not limited to Examples shown below.

### Example 1

A copper alloy which contains 0.1-1.0 mass % of Cr shown in Table 1, 0.05-1.5 mass % of Sn, and 0.05-1.5 mass % of Zn, and which consists of the remainder Cu and unavoidable impurities, was dissolved in a high frequency dissolution furnace. The result was cast at a cooling rate of 10-30° C./second, and ingots with thickness of 30 mm, width of 100 mm, and length of 150 mm were manufactured. Hot flatting (rolling) was performed to the ingot to obtain a hot flatted material having a thickness of 12 mm. Subsequently, both sides of the material were surface-ground by 1 mm each, and the material was cold flatted (rolled) to obtain a cold flatted material having a thickness of 0.67-1.2 mm. Aging treatment was performed to the cold flatted material, and finally, the final cold flatting (rolling) was applied with the flatting rate of 10-50% (In the Tables herein, the final flatting (rolling) rate is represented as Red(%).), and test material having entire thickness of 0.6 mm was produced.

As to the manufactured test device, the characteristics were measured by the below method, and the result is shown in Table 2. In Table 2, GW shows characteristics due to the test piece taken in the parallel direction to the flatting, and BW shows characteristics due to the test piece that was taken in the perpendicular direction to the flatting.

### (a) Electrical Conductivity (EC)

A test piece having width of 5 mm and length of 300 mm was cut down in the parallel direction to the flatting and the perpendicular direction to the flatting was immersed in a constant temperature chamber maintained at 20° C. (±0.5° C.), and the specific resistance was measured by using a four 4 terminal method to obtain the electrical conductivity. The distance between the terminals was 100 mm.

### (b) Tension Strength (TS)

Test pieces specified in JIS Z2201 No. 5, which was cut in the parallel direction to the flatting and the perpendicular direction to the flatting, were tested pursuant to JIS Z2241, and the mean values were obtained.

### (c) Stress Relaxation Characteristic (SR)

A test piece of the dimensions shown in FIG. 2 was cut down from the testing material, a slit (penetrated slot) with a width (w) of 1 mm was provided in the test piece, a brass material (sliding material) of 1.2 mm of thickness (w) was inserted in the slit, the change of the slit interval after elapsing the examination time at each examination temperature was measured, and the stress relaxation rate was obtained. It is noted that the examination was performed in the two directions, the parallel direction to the flatting and the perpendicular direction to the flatting.

The following shows the detailed test method:

(1) Insert a brass material in a slit in normal temperature, and hold for 1 minute.

Upon inserting the brass material, the material containing the slit is fixed, and the brass plate is struck lightly with a hammer and inserted in the slit.

(2) After elapsing 1 minute, while uncovering the brass plate and observing upper part of the silt with an optical microscope, the upper part of the slit was taken photographs (×100), and the slit interval was measured. The width is assumed as an initial value w.

(3) Again, The brass plate is inserted and charged to a constant temperature chamber maintained at 150° C. However, since the plate thickness changes slightly if the brass plate is inserted once, the same brass plate will not be used.

(4) The test piece is taken out from the constant temperature chamber for every fixed time and air-cooled to normal temperature, and thereafter, the photograph of the same position of the upper part of the slit was taken as in (2), and the slit interval w was measured. Then, the brass plate is inserted again as in (3). The work is repeated until elapsing 1,000 hours and the stress relaxation characteristic was evaluated by measuring the change of the width of the slit continuously.

(5) The stress relaxation rate SR is computed with Expression 1.

### (d) Dimension and Dispersion Density of Cr Deposited Substance

The dimension and dispersion density of Cr deposited substance were measured using a transmission electron microscope (TEM).

The value was obtained by making the testing material into a thin film by an electrolytic polishing thin film method (twin jet polishing method), observing arbitrary views by magnification ratio of 50,000, taking three photographs arbitrarily, and analyzing the photograph. At this time, (111) or (200) was used as an incidence direction angle.

As for the dimension and the dispersion density of the deposited substance, the dimension (PPT) and the dispersion density (PPT×10²/μm²) were computed by counting approximately 50-1,000 of the deposited substances. Since the number of the deposited substance decreases if the dimension of the deposited substance is large, the photographs were taken for three more views when the number was extremely few. The taken photograph was analyzed with an image analysis device, and the number of the deposited substances and the average dimension were computed.

### (e) Bending Characteristic

The testing material processed to obtain a dimension with a width of 10 mm and a length of 25 mm, the minimum bending radius R (mm) that does not crack in the bent surface when it is bent 90 degrees was obtained, and the relationship R/t with the thickness t (mm) was obtained. As for the value of R/t, the value which becomes large among the above-mentioned test pieces for GW and BW was used.

(f) A non-gloss Sn plating of about 2 μm was applied to the plating adhesiveness testing material, and thereafter, the test piece which imitated simply the reflow Sn plating state was produced by re-heating on a hot plate at a temperature of 250° C.

The test piece for which a simple reflow Sn plating was applied was heated at 80° C., 100° C., and 120° C. for 10 minutes each, and thereafter, 90 degrees V bending test with a bending radius of 1 mm (r=1.0) was performed, and whether the Sn plating of the surface of the bending processed part was exfoliated or not was observed by the microscope. Here, the case where the exfoliation was not observed was evaluated as “A”, the case where the exfoliation of the Sn plating at the surface was observed but it was less than 50% of the area of the bending apex region was evaluated as “B”, and the case where the exfoliation of the Sn plating extends 50% or more of the area of the bending apex region was evaluated as “C.” The result of the plating adhesiveness characteristic was shown in “evaluation” clauses for each of the tables.

TABLE 1

| | | Cr | Sn | Zn | Red |
|---|---|---|---|---|---|
| | No. | mass % | mass % | mass % | % |
| PRESENT | 1 | 0.10 | 0.06 | 0.06 | 45 |
| INVENTION | 2 | 0.25 | 0.21 | 0.21 | 35 |
| | 3 | 0.26 | 0.21 | 0.21 | 40 |
| | 4 | 0.25 | 0.21 | 0.31 | 35 |
| | 5 | 0.25 | 0.21 | 0.30 | 40 |
| | 6 | 0.25 | 0.31 | 0.20 | 35 |
| | 7 | 0.25 | 0.31 | 0.20 | 40 |
| | 8 | 0.26 | 0.31 | 0.30 | 35 |
| | 9 | 0.26 | 0.30 | 0.30 | 40 |
| | 10 | 0.26 | 0.41 | 0.21 | 35 |
| | 11 | 0.26 | 0.40 | 0.21 | 40 |
| | 12 | 0.26 | 0.40 | 0.31 | 35 |
| | 13 | 0.26 | 0.41 | 0.30 | 40 |
| | 14 | 0.26 | 0.50 | 0.21 | 35 |
| | 15 | 0.26 | 0.50 | 0.20 | 40 |
| | 16 | 0.26 | 0.51 | 0.31 | 35 |
| | 17 | 0.25 | 0.50 | 0.30 | 40 |
| | 18 | 0.30 | 0.21 | 0.21 | 30 |
| | 19 | 0.31 | 0.20 | 0.20 | 35 |
| | 20 | 0.31 | 0.20 | 0.30 | 30 |
| | 21 | 0.30 | 0.21 | 0.31 | 35 |
| | 22 | 0.30 | 0.31 | 0.20 | 30 |
| | 23 | 0.30 | 0.30 | 0.21 | 35 |
| | 24 | 0.30 | 0.31 | 0.30 | 30 |
| | 25 | 0.31 | 0.30 | 0.31 | 35 |
| | 26 | 0.30 | 0.40 | 0.20 | 30 |
| | 27 | 0.31 | 0.41 | 0.21 | 35 |
| | 28 | 0.31 | 0.40 | 0.30 | 30 |
| | 29 | 0.30 | 0.40 | 0.30 | 35 |
| | 30 | 0.30 | 0.51 | 0.21 | 30 |
| | 31 | 0.30 | 0.51 | 0.20 | 35 |
| | 32 | 0.30 | 0.50 | 0.30 | 30 |
| | 33 | 0.30 | 0.51 | 0.30 | 35 |
| | 34 | 0.40 | 0.21 | 0.20 | 30 |
| | 35 | 0.40 | 0.20 | 0.20 | 35 |
| | 36 | 0.40 | 0.20 | 0.31 | 30 |
| | 37 | 0.41 | 0.21 | 0.31 | 35 |
| | 38 | 0.40 | 0.31 | 0.21 | 30 |
| | 39 | 0.40 | 0.31 | 0.21 | 35 |
| | 40 | 0.41 | 0.31 | 0.31 | 30 |
| | 41 | 0.41 | 0.31 | 0.31 | 35 |
| | 42 | 0.40 | 0.40 | 0.20 | 30 |
| | 43 | 0.40 | 0.41 | 0.20 | 35 |
| | 44 | 0.40 | 0.40 | 0.31 | 30 |
| | 45 | 0.40 | 0.40 | 0.31 | 35 |
| | 46 | 0.40 | 0.51 | 0.20 | 30 |
| | 47 | 0.40 | 0.50 | 0.21 | 35 |
| | 48 | 0.40 | 0.51 | 0.30 | 30 |
| | 49 | 0.41 | 0.50 | 0.31 | 35 |
| | 50 | 0.51 | 0.51 | 0.50 | 30 |
| | 51 | 0.51 | 1.01 | 1.00 | 35 |

TABLE 2

| | | TS(GW) | TS(BW) | EC(GW) | EC(BW) | PPT | PPT × 10²/ | SR(GW) | SR(BW) | | |
|---|---|---|---|---|---|---|---|---|---|---|---|
| | No. | MPa | MPa | % IACS | % IACS | μm | μm² | % | % | R/t | |
| PRESENT | 1 | 410 | 424 | 79 | 78 | 0.023 | 0.06 | 45 | 43 | 1.8 | A |
| INVENTION | 2 | 407 | 423 | 75 | 75 | 0.028 | 0.54 | 35 | 34 | 1.4 | A |
| | 3 | 414 | 425 | 75 | 75 | 0.023 | 0.56 | 40 | 37 | 1.6 | A |
| | 4 | 410 | 427 | 74 | 74 | 0.030 | 0.99 | 35 | 33 | 1.4 | A |
| | 5 | 415 | 422 | 74 | 74 | 0.024 | 0.61 | 40 | 39 | 1.6 | A |
| | 6 | 411 | 422 | 73 | 73 | 0.029 | 0.11 | 35 | 35 | 1.4 | A |
| | 7 | 408 | 427 | 73 | 73 | 0.027 | 1.12 | 40 | 39 | 1.6 | A |
| | 8 | 406 | 426 | 72 | 72 | 0.023 | 0.32 | 35 | 33 | 1.4 | A |
| | 9 | 409 | 423 | 72 | 72 | 0.024 | 0.48 | 41 | 37 | 1.6 | A |
| | 10 | 412 | 422 | 72 | 72 | 0.023 | 0.17 | 36 | 33 | 1.4 | A |
| | 11 | 409 | 428 | 72 | 72 | 0.027 | 0.69 | 40 | 39 | 1.6 | A |
| | 12 | 409 | 428 | 71 | 71 | 0.027 | 0.42 | 35 | 33 | 1.4 | A |
| | 13 | 413 | 427 | 71 | 71 | 0.024 | 0.90 | 40 | 38 | 1.6 | A |
| | 14 | 413 | 428 | 70 | 70 | 0.026 | 0.95 | 35 | 33 | 1.4 | A |
| | 15 | 409 | 430 | 70 | 70 | 0.025 | 0.78 | 40 | 38 | 1.6 | A |
| | 16 | 411 | 424 | 69 | 69 | 0.024 | 0.51 | 35 | 33 | 1.4 | A |
| | 17 | 413 | 421 | 69 | 69 | 0.029 | 0.36 | 40 | 37 | 1.6 | A |
| | 18 | 408 | 429 | 75 | 75 | 0.023 | 0.92 | 30 | 27 | 1.2 | A |
| | 19 | 415 | 422 | 75 | 75 | 0.025 | 0.26 | 35 | 34 | 1.4 | A |
| | 20 | 408 | 427 | 74 | 74 | 0.028 | 0.26 | 30 | 30 | 1.2 | A |
| | 21 | 414 | 422 | 74 | 74 | 0.027 | 1.06 | 35 | 34 | 1.4 | A |
| | 22 | 409 | 425 | 73 | 73 | 0.021 | 1.19 | 31 | 28 | 1.2 | A |
| | 23 | 415 | 427 | 73 | 73 | 0.021 | 1.08 | 35 | 34 | 1.4 | A |
| | 24 | 406 | 429 | 72 | 72 | 0.021 | 1.02 | 30 | 28 | 1.2 | A |
| | 25 | 414 | 428 | 72 | 72 | 0.021 | 1.23 | 35 | 33 | 1.4 | A |
| | 26 | 414 | 422 | 72 | 72 | 0.029 | 1.23 | 30 | 29 | 1.2 | A |
| | 27 | 406 | 424 | 72 | 72 | 0.029 | 1.98 | 35 | 33 | 1.4 | A |
| | 28 | 411 | 427 | 71 | 71 | 0.024 | 1.74 | 31 | 28 | 1.2 | A |
| | 29 | 406 | 427 | 71 | 71 | 0.022 | 1.83 | 35 | 32 | 1.4 | A |
| | 30 | 409 | 421 | 70 | 70 | 0.024 | 1.66 | 30 | 29 | 1.2 | A |
| | 31 | 415 | 421 | 70 | 70 | 0.024 | 1.24 | 35 | 33 | 1.4 | A |
| | 32 | 411 | 427 | 69 | 69 | 0.028 | 1.76 | 30 | 27 | 1.2 | A |
| | 33 | 414 | 422 | 69 | 69 | 0.026 | 1.72 | 35 | 34 | 1.4 | A |
| | 34 | 406 | 426 | 75 | 75 | 0.026 | 1.67 | 30 | 27 | 1.2 | A |
| | 35 | 410 | 428 | 75 | 75 | 0.026 | 2.80 | 35 | 32 | 1.4 | A |
| | 36 | 413 | 427 | 74 | 74 | 0.026 | 2.28 | 30 | 28 | 1.2 | A |
| | 37 | 408 | 425 | 74 | 74 | 0.029 | 2.96 | 34 | 31 | 1.4 | A |
| | 38 | 406 | 422 | 73 | 73 | 0.030 | 2.14 | 30 | 28 | 1.2 | A |
| | 39 | 412 | 428 | 73 | 73 | 0.028 | 2.44 | 36 | 33 | 1.4 | A |
| | 40 | 416 | 423 | 72 | 72 | 0.030 | 2.02 | 29 | 29 | 1.2 | A |
| | 41 | 413 | 427 | 72 | 72 | 0.022 | 2.87 | 35 | 32 | 1.4 | A |
| | 42 | 415 | 426 | 72 | 72 | 0.027 | 2.40 | 30 | 27 | 1.2 | A |
| | 43 | 412 | 421 | 72 | 72 | 0.021 | 2.84 | 35 | 32 | 1.4 | A |
| | 44 | 414 | 423 | 71 | 71 | 0.021 | 2.68 | 29 | 29 | 1.2 | A |
| | 45 | 411 | 421 | 71 | 71 | 0.021 | 2.83 | 35 | 32 | 1.4 | A |
| | 46 | 409 | 423 | 70 | 70 | 0.028 | 2.88 | 30 | 28 | 1.2 | A |
| | 47 | 410 | 424 | 70 | 70 | 0.026 | 2.46 | 35 | 33 | 1.4 | A |
| | 48 | 414 | 422 | 69 | 69 | 0.022 | 2.62 | 30 | 28 | 1.2 | A |
| | 49 | 413 | 428 | 69 | 69 | 0.027 | 2.94 | 36 | 32 | 1.4 | A |
| | 50 | 411 | 426 | 67 | 67 | 0.027 | 2.20 | 29 | 28 | 1.2 | A |
| | 51 | 408 | 425 | 55 | 55 | 0.028 | 2.49 | 35 | 32 | 1.4 | A |

As clear from Tables 1 and 2, all of the materials Nos. 1-51 according to the present invention satisfied the characteristics of the evaluation items a-f. Moreover, all the values of R/t which shows the bending characteristic also become 2 or less, and showed good bending characteristic.

### Example 2

As shown in Table 3, copper alloy in which appropriate amount of Al, Zr, Ti, Fe, P, Si, and Mg are added in addition to Cr, Sn, and Zn, is used. As to others, the testing material is made by the same method as in Example 1, and the characteristic evaluation was performed by the same evaluation criteria as in Example 1. The result is shown in Table 4.

TABLE 3

| | | Cr | Sn | Zn | P | Si | Mg | Extra | Red |
|---|---|---|---|---|---|---|---|---|---|
| | No. | mass % | mass % | mass % | mass % | mass % | mass % | mass % | % |
| PRESENT | 60 | 0.245 | 0.201 | 0.207 | 0.01 | | | | 45 |
| INVENTION | 61 | 0.245 | 0.204 | 0.203 | 0.03 | | | | 35 |
| | 62 | 0.246 | 0.208 | 0.306 | | 0.02 | | | 40 |
| | 63 | 0.249 | 0.200 | 0.307 | | 0.03 | | | 35 |
| | 64 | 0.245 | 0.308 | 0.203 | | 0.07 | | | 36 |
| | 65 | 0.248 | 0.305 | 0.205 | | 0.03 | | Fe = 0.002 | 37 |
| | 66 | 0.249 | 0.306 | 0.305 | | 0.04 | | Zr = 0.001 | 38 |
| | 67 | 0.246 | 0.307 | 0.305 | | 0.02 | | Ti = 0.01 | 39 |
| | 68 | 0.244 | 0.406 | 0.209 | | 0.04 | | Al = 0.03 | 40 |
| | 69 | 0.243 | 0.409 | 0.207 | | | 0.008 | | 41 |
| | 70 | 0.243 | 0.405 | 0.308 | | | 0.03 | | 42 |
| | 71 | 0.245 | 0.408 | 0.309 | 0.005 | 0.05 | | | 43 |
| | 72 | 0.240 | 0.503 | 0.207 | 0.25 | 0.025 | | | 44 |
| | 73 | 0.241 | 0.504 | 0.204 | 0.005 | | 0.008 | Fe = 0.003 | 45 |
| | 74 | 0.242 | 0.508 | 0.308 | | 0.07 | 0.001 | | 46 |
| | 75 | 0.241 | 0.504 | 0.306 | 0.005 | 0.03 | 0.005 | | 47 |

TABLE 4

| | | TS(GW) | TS(BW) | EC(GW) | EC(BW) | PPT | PPT × 10²/ | SR(GW) | SR(BW) | | EVALU- |
|---|---|---|---|---|---|---|---|---|---|---|---|
| | No. | MPa | MPa | % IACS | % IACS | μm | μm² | % | % | R/t | ATION |
| PRESENT | 60 | 409 | 427 | 75 | 75 | 0.024 | 0.33 | 44 | 43 | 1.8 | A |
| INVENTION | 61 | 410 | 429 | 75 | 75 | 0.028 | 0.73 | 35 | 33 | 1.4 | A |
| | 62 | 410 | 422 | 74 | 74 | 0.021 | 0.83 | 39 | 38 | 1.8 | A |
| | 63 | 413 | 430 | 74 | 74 | 0.025 | 0.83 | 36 | 34 | 1.4 | A |
| | 64 | 414 | 427 | 73 | 73 | 0.027 | 1.07 | 35 | 33 | 1.4 | A |
| | 65 | 412 | 424 | 73 | 73 | 0.024 | 0.47 | 37 | 36 | 1.5 | A |
| | 66 | 408 | 430 | 72 | 72 | 0.027 | 0.91 | 38 | 36 | 1.5 | A |
| | 67 | 409 | 421 | 72 | 72 | 0.022 | 1.09 | 40 | 37 | 1.8 | A |
| | 68 | 409 | 429 | 72 | 72 | 0.024 | 0.80 | 40 | 39 | 1.6 | A |
| | 69 | 415 | 421 | 72 | 72 | 0.029 | 0.98 | 41 | 38 | 1.6 | A |
| | 70 | 415 | 423 | 71 | 71 | 0.029 | 0.46 | 42 | 40 | 1.7 | A |
| | 71 | 412 | 422 | 71 | 71 | 0.023 | 0.89 | 43 | 42 | 1.7 | A |
| | 72 | 411 | 423 | 70 | 70 | 0.027 | 0.79 | 45 | 43 | 1.8 | A |
| | 73 | 406 | 427 | 70 | 70 | 0.027 | 0.15 | 45 | 42 | 1.8 | A |
| | 74 | 411 | 425 | 69 | 69 | 0.021 | 0.36 | 45 | 43 | 1.8 | A |
| | 75 | 407 | 425 | 69 | 69 | 0.028 | 0.97 | 48 | 45 | 1.9 | A |

As clear from Tables 3 and 4, all of the materials Nos. 60-75 according to the present invention satisfied the characteristic of evaluation items a-f. Moreover, all of the values of R/t which showed the bending characteristic also became 2 or less, and good bending characteristic.

### Example of Comparison

Flatted plates having constituent composition and manufacturing condition shown in Table 5 were manufactured with the same method as Example 1 or 2, and the same characteristic evaluation with Example 1 was performed. The result is shown in Table 6.

TABLE 5

| | | Cr | Sn | Zn | Red |
|---|---|---|---|---|---|
| | No. | mass % | mass % | mass % | % |
| COMPARISON | 101 | 0.08 | 0.05 | 0.05 | 45 |
| EXAMPLE | 102 | 0.11 | 0.05 | 0.04 | 45 |
| | 103 | 0.10 | 1.80 | 1.80 | 45 |
| | 104 | 0.20 | 1.81 | 1.81 | 35 |
| | 105 | 0.51 | 0.05 | 0.04 | 30 |
| | 106 | 0.51 | 1.80 | 1.80 | 35 |
| | 107 | 1.01 | 0.04 | 0.05 | 30 |
| | 108 | 1.00 | 1.81 | 1.81 | 35 |
| | 109 | 1.21 | 0.05 | 0.05 | 30 |
| | 110 | 1.20 | 1.80 | 1.81 | 35 |
| | 111 | 0.11 | 0.06 | 0.05 | 60 |
| | 112 | 0.20 | 0.20 | 0.21 | 55 |
| | 113 | 0.20 | 0.31 | 0.30 | 55 |
| | 114 | 0.31 | 0.20 | 0.21 | 55 |
| | 115 | 0.31 | 0.30 | 0.31 | 55 |
| | 116 | 0.41 | 0.20 | 0.30 | 55 |
| | 117 | 0.41 | 0.41 | 0.41 | 55 |
| | 118 | 0.50 | 0.20 | 0.20 | 55 |
| | 119 | 0.50 | 0.51 | 0.51 | 55 |
| | 120 | 1.00 | 1.51 | 1.50 | 55 |

TABLE 6

| | | TS(GW) | TS(BW) | EC(GW) | EC(BW) | PPT | PPT × 10²/ | SR(GW) | SR(BW) | | EVALU- |
|---|---|---|---|---|---|---|---|---|---|---|---|
| | No. | MPa | MPa | % IACS | % IACS | μm | μm² | % | % | R/t | ATION |
| COMPARISON | 101 | 385 | 411 | 79 | 79 | 0.024 | 0.64 | 58 | 57 | 2.2 | A |
| EXAMPLE | 102 | 390 | 429 | 79 | 79 | 0.021 | 0.48 | 52 | 50 | 2.2 | A |
| | 103 | 402 | 422 | 35 | 35 | 0.025 | 0.24 | 46 | 43 | 1.8 | A |
| | 104 | 409 | 425 | 35 | 35 | 0.023 | 1.03 | 34 | 33 | 1.4 | A |
| | 105 | 394 | 423 | 79 | 79 | 0.025 | 1.24 | 30 | 27 | 1.2 | A |
| | 106 | 405 | 421 | 35 | 35 | 0.024 | 0.61 | 38 | 34 | 1.4 | A |
| | 107 | 392 | 412 | 79 | 79 | 0.026 | 1.10 | 29 | 28 | 1.2 | A |
| | 108 | 402 | 422 | 35 | 35 | 0.020 | 1.02 | 38 | 32 | 1.4 | A |
| | 109 | 389 | 427 | 79 | 79 | 0.029 | 1.30 | 30 | 28 | 1.2 | A |
| | 110 | 404 | 429 | 35 | 35 | 0.029 | 0.75 | 35 | 33 | 1.4 | A |
| | 111 | 387 | 429 | 79 | 79 | 0.022 | 1.05 | 59 | 58 | 2.4 | C |
| | 112 | 412 | 448 | 75 | 75 | 0.025 | 2.10 | 57 | 55 | 2.2 | B |
| | 113 | 419 | 444 | 72 | 72 | 0.025 | 1.25 | 56 | 55 | 2.2 | C |
| | 114 | 412 | 445 | 75 | 75 | 0.022 | 2.86 | 57 | 55 | 2.2 | B |
| | 115 | 419 | 442 | 72 | 72 | 0.029 | 1.02 | 57 | 54 | 2.2 | C |
| | 116 | 421 | 442 | 74 | 74 | 0.024 | 2.94 | 56 | 54 | 2.2 | B |
| | 117 | 420 | 448 | 70 | 70 | 0.020 | 2.98 | 58 | 55 | 2.2 | B |
| | 118 | 415 | 450 | 75 | 75 | 0.028 | 2.75 | 55 | 56 | 2.2 | B |
| | 119 | 416 | 441 | 67 | 67 | 0.021 | 2.86 | 57 | 54 | 2.2 | B |
| | 120 | 416 | 441 | 42 | 42 | 0.026 | 3.93 | 57 | 54 | 2.2 | B |

As clear from Tables 5 and 6, the comparison materials Nos. 101-120 did not satisfy either one of characteristic of evaluation items a-f. Moreover, there are some that has the value of R/t which shows the bending characteristic exceeds 2, and some showed bending characteristics that are not good.

### INDUSTRIAL APPLICABILITY

The flatted plate of the present invention may be used suitable for electric and electronic devices. The flatted plate of the present invention is used especially suitably for flatted plates made from copper alloy, which constitute connectors, terminals, and bus bars, etc., used in electric and electronic devices incorporated in mobile units, such as an automobile and a train.

While the present invention has been described with reference to the embodiments, it is not meant to limit the present invention in any of the details of the descriptions, and it is considered that the present invention should be construed broadly as long as it does not contradict with the accompanying claims.

The application claims priority from a Japanese patent application serial No. 2007-016064 filed on Jan. 26, 2007 and a Japanese patent application serial No. 2008-014277 filed on Jan. 26, 2007, the entire contents of which are incorporated herein by the reference.

1. A flatted material formed through cold flatting a copper alloy containing 0.1-1.0 mass % of Cu, 0.05-1.5 mass % of Sn, 0.05-1.5 mass % of Zn, a residual amount of Cu, and unavoidable impurities, wherein said flatted material has stress relaxation rates of 50% or less in a direction parallel to a flatting direction thereof and in a direction perpendicular to the flatting direction after 1,000 hours of an insertion type stress relaxation test at 150° C.

2. The flatted material according to claim 1, wherein said flatted material has tension strengths of 400 MPa or greater in the direction parallel to the flatting direction and the direction perpendicular to the flatting direction, said flatted material having electric conductivities of 40% IACS or greater in the direction parallel to the flatting and the direction perpendicular to the flatting direction, said flatted material containing Cr particles having a size of 5-50 nm and a dispersion density of 10²-10³ pieces/μm².

3. The flatted material according to claim 2, wherein said flatted material has a surface coated with an Sn layer or an Sn alloy layer having a thickness of 0.5-5 μm.

4. The flatted material according to claim 1, wherein said copper alloy constituting the flatted material includes a total amount of 0.005-0.5 mass % of at least one selected from the group consisting of Al, Zr, Ti, Fe, P, Si, and Mg.

5. The flatted material according to claim 1, wherein said flatted material is processed at a final flatting processing rate of 10% to 50%.

6. The flatted material according to claim 1, wherein said flatted material is used for a terminal of a control unit or a bus bar.
